(19) United States
(12) Patent Application Publication
(10) Pub. No.: US 2026/0356260 A1
(43) Pub. Date: Nov. 12, 2026

(54) SECURING SYSTEM FOR CHILD SAFETY SEAT

(71) Applicant: CYBEX GmbH, Bayreuth (DE)

(72) Inventors: Martin Kreis, Bayreuth (DE); Stoil BOZHIKOV, Bayreuth (DE); Harald KOHLMANN, Bayreuth (DE)

(21) Appl. No.: 19/118,913

(22) PCT Filed: Sep. 29, 2023
(86) PCT No.: PCT/EP2023/077080

§ 371 Date: Apr. 7, 2025

(30) Foreign Application Priority Data
Oct. 7, 2022 (DE) 20 2022 105 669.2

(51) Int. Cl. B60N 2/28

(52) U.S. Cl. CPC B60N 2/2887; B60N 2/2821

(57) ABSTRACT

The invention relates to a telescopic system for fastening a child seat or a base for a child seat to a motor vehicle seat. The telescopic system comprises a first section and a second section, wherein the first and second sections are displaceable relative to one another in a longitudinal direction in order to adjust a length of the telescopic system. A first latch is fastened in or on the second section, wherein the telescopic system can be brought into at least a first, second and third configuration. In the first configuration, the adjustment of the length of the telescopic system is enabled, in the second configuration the adjustment of the length of the telescopic system is enabled to a limited extent compared to the first configuration, and, in the third configuration, the adjustment of the length of the telescopic system is enabled to a further limited extent compared to the second configuration or is not possible.

The invention relates to a telescopic system for fastening a child seat and/or a base for a child seat to a motor vehicle seat.

A child seat is understood by a person skilled in the art to be a child restraint system intended for transporting a child in a vehicle, preferably a motor vehicle.

In this context, it should be noted that in the context of the present invention, the term “child seat” is to be understood as a generic term for (classic) child seats, infant carriers, booster seats, booster cushions, etc. Thus, features provided for a child seat in the context of the present invention are in principle also applicable to an infant carrier and vice versa, as long as nothing to the contrary is mentioned. The same applies to the term “child”, which is also to be understood as a generic term for children, babies and infants.

It should be noted that in the context of the present invention, the term “child seat” is to be understood as a generic term for (classic) child seats, infant carriers, booster seats, booster cushions, etc. For example, the child seat of the present invention may be a (classic) child seat (for larger children, e.g. Group I/II and/or III child seat) which has a backrest which is structurally separated from a seat area and whose inclination can be varied relative to the seat area if necessary. The structural boundary can be formed, for example, by a kink or similar. In general, however (unless otherwise stated in the specific context) child seat is always to be understood as an abbreviated form of writing for “child seat, for example infant carrier, booster seat and/or booster cushion” or, in the context of the present invention, features provided for a (classic) child seat are in principle also applicable, for example, to an infant carrier, a booster seat and/or a booster cushion and vice versa (unless otherwise stated). The same applies to the term “child”, which is also to be understood as a generic term for children, babies and infants. So-called “infant carriers” often (only) comprise a one-piece shell for holding the baby or child and may include a separate belt system, possibly a headrest and possibly other components. Instead of a (structurally delimited) backrest, such “infant carriers” have a back section that adjoins a “seat area” in which the child's buttocks can be accommodated.

The term “base for a child seat” is understood by a person skilled in the art to mean, in particular, a base to which a child seat can be detachably or non-detachably fastened.

Child seats, infant carriers, booster seats etc. that can be fastened to a vehicle seat have been known for some time. Such child seats, infant carriers, booster seats etc. serve as seating for children, babies and infants and offer them increased protection, especially in the event of an accident and/or emergency braking. Such child seats can be secured using the car's belt system or by means of an Isofix anchorage. This type of fastening secures the child seat to the car seat in the event of an accident, so that it is held in place on the car seat and not thrown forward, particularly in the event of a rear-end collision (impact) and/or emergency braking.

Since such child seats often have to be changed or installed and removed between different vehicles, especially motor vehicles, it is particularly important that the detachable anchorage of a child seat enables user-friendly handling. Furthermore, however, easier handling should not be at the expense of the child's safety in road traffic or in the event of an accident.

The fastening of the child seat to the vehicle seat must therefore be as stable as possible. At the same time, however, it is also desirable if the fastening allows a certain degree of adjustability so that it can be optimally adapted to different car seats.

An adjustable telescopic system for fastening a child restraint system to a vehicle seat is known, for example, from EP 3 600 954 B1. However, the fastening system disclosed there consists of a large number of different individual parts, which means that the design is considered to be in need of improvement in terms of manufacturing costs and susceptibility to faults during use.

It is therefore the object of the present invention to propose a telescopic system for fastening a child seat and/or a base for a child seat to a motor vehicle seat, which fulfills the requirements described above with regard to stability, user-friendliness, safety and universal applicability in the most cost-effective and least error-prone manner possible.

This object is solved in particular by the features of claim 1

In particular, the object is solved by a telescopic system for fastening a child seat and/or a base for a child seat to a motor vehicle seat, wherein the telescopic system comprises a first section and a second section, wherein the first and second sections are displaceable relative to one another (in a longitudinal direction) in order to adjust a length of the telescopic system (wherein the sections are guided to one another via at least one first guide, wherein one of the first section and/or second section is preferably guided directly or indirectly in the longitudinal direction by at least one first guide on the other of the first section and second section), wherein a first latch is fastened in or on the second section, wherein the telescopic system can be brought into at least a first, second and third configuration, wherein in the first configuration the adjustment of the length of the telescopic system is enabled, in the second configuration the adjustment of the length of the telescopic system is enabled to a limited extent in comparison to the first configuration and in the third configuration the adjustment of the length of the telescopic system is enabled to a further limited extent compared to the second configuration or is (at least essentially) not possible.

One idea of the invention is that, in contrast to the above-mentioned prior art, the length of the telescopic system is advantageously adjusted with only one latch, namely the first latch, in accordance with the above-mentioned configurations. As a result, the telescopic system of the present invention is characterized by constructive simplicity, while at the same time there are no restrictions in functionality compared to the prior art (with two latches).

Unless expressly stated otherwise, the terms “first”, “second” etc., e.g. first hook or second spring, are used to distinguish different elements from one another. The presence of a first spring or a second spring does not therefore imply that there must necessarily be more than one spring.

The first and second sections are displaceable relative to one another, wherein this is to be understood in particular in such a way that the first section and the second section can be moved relative to one another (in particular translationally, preferably in the longitudinal direction).

Furthermore, the telescopic system can have a transfer element (described in more detail below) which is suitable for driving the first latch to be transferred from its extended position to its retracted position.

Preferably, the first section is fastened or can be fastened to the child seat or the base for the child seat, optionally detachably, and/or is integrally formed at least in sections with the child seat or the base for the child seat, wherein the second section is preferably provided for detachable fastening to a motor vehicle seat (wherein the motor vehicle seat in particular has a seat surface and a backrest) and has a proximal end and a distal end, wherein further preferably at least one or exactly one first hook is provided in the region of the distal end of the second section, which is suitable for engaging around a bracket provided on the vehicle side, in particular an Isofix anchorage or an anchorage according to standard ISO 13216 or UN ECE R 145, in order to couple the telescopic system to the motor vehicle seat, wherein the first hook is switchable between a first position, in which it does not couple the telescopic system to the motor vehicle seat, and a second position, in which it couples the telescopic system to the motor vehicle seat.

The motor vehicle seat can (at least approximately) have at least one, preferably exactly two, brackets in the transition area between the seat surface and the backrest, which can (in each case) be gripped by the first hook of the telescopic system. The child seat or the base for a child seat can have an underside which is intended to rest on the seat surface of the motor vehicle seat. The child seat or the base for a child seat can have a rear side which is intended to face the backrest of the motor vehicle seat and, optionally, rest against it.

Sections of the telescopic system can be flush with the underside and/or the rear side of the child seat or the base for a child seat.

In embodiments, the first and/or second section have (at least substantially) a square and/or rectangular cross-section, at least in sections.

The first and/or second section are preferably at least substantially profile-like in design (or as profile(s)), optionally hollow and/or tubular.

According to the embodiment, the first and/or second section have a maximum height (considered over a longitudinal extension) and/or a maximum diameter (considered over a longitudinal extension) of less than or equal to 5 cm, preferably 2 cm-3.5 cm.

The first and/or second section have a maximum width (considered over a longitudinal extension) of less than or equal to 3 cm, preferably 1.0 cm-2.0 cm.

The first section can surround or enclose the second section in sections.

The first section is preferably at most 40 cm long and/or at least half as long as the second section and/or at least 2 cm, preferably at least 4 cm long.

The second section is preferably at least 4 cm long, further preferably at least 8 cm long and/or at most 40 cm long, preferably at most 30 cm long (e.g. 20 cm long).

In embodiments, the second section has a number of preferably inwardly directed projections. Each of the projections can be formed over an entire width (transverse to the longitudinal direction, in particular in the left-right direction) or over part of the width of the second section. Each of the projections can, for example, be formed as a bulge and/or be formed as a bolt.

The second section preferably has a first projection for supporting the first hook in its first position.

In addition, the second section preferably has a second projection, optionally a plurality of second projections, for guiding a latch and/or at least one third projection for guiding the transfer element. At least one optional fourth projection of the second section can serve to support the first latch in its extended position.

The first hook is preferably pretensioned towards its first position, in particular by a first spring. In particular, when the first hook is pretensioned towards the first position, a second latch (see further below) may be provided in or on the second section of the telescopic system. The first hook may be rotatable about a first axis, which is preferably stationary relative to the second section. Furthermore, the first hook can have a first axis section or a first bearing section. The first hook can also have a locking section which is suitable for engaging around the vehicle-side bracket and/or be C-shaped or U-shaped.

The locking section can in particular have two opposing legs, wherein one of the legs can be adjacent to an actuating section of the first hook. The first spring can be fastened to a/the first axis on the first hook, in particular supported and/or mounted, and/or the first spring can be designed as a torsion spring.

Alternatively, the first spring can be fastened to the first hook at a distance from the first axis, in particular supported and/or mounted, and/or the first spring can be designed as a tension spring. Other types of springs are also conceivable in principle.

A first (functional) end of the first spring can be supported on the first hook. A second end of the first spring can be supported on the second section. The first and a second spring (see further below) may also be identical and formed by a single (first/second) spring, which simultaneously pretensions the first hook towards the first position and pretensions the second latch towards a locking position (see further below). This is preferably achieved by a first end of the first/second spring being supported on the first hook and a second end of the first/second spring being supported on the second latch (or optionally on the transfer element).

Furthermore, a force acting on the actuating section in the longitudinal direction (e.g. as a result of pressing against the vehicle-side bracket), namely from the distal end of the second section towards the proximal end of the second section, can drive the first hook to be transferred from the first position to the second position.

Preferably, the telescopic system is completely retractable in the child seat or in the base for a child seat. The first section can be mounted on the child seat or the base for a child seat in such a way that it is completely retracted or at least partially flush with the child seat or the base for a child seat. The second section, in turn, can be adjusted in at least one position relative to the first section so that it is also completely recessed or at least partially flush with the child seat or the base for a child seat.

The minimum length of the telescopic system and the maximum length of the telescopic system can differ by at least 4 cm, preferably at least 8 cm and/or at most 30 cm, preferably at most 20 cm.

A maximum projection of the telescopic system over the child seat or the base of the child seat can be at least 4 cm, preferably at least 8 cm, and/or at most 30 cm, preferably at most 20 cm.

Preferably, a second latch, in particular the one already described above, is provided in and/or on the second section, which is adjustable between a locking position, in particular the one already described above, in which the second latch holds the first hook in its second position and/or a release position in which the second latch does not hold the first hook in its second position.

The second latch can be pretensioned towards the locking position, in particular by a second spring, in particular the second spring already described above, in particular a tension spring. A first end of the second spring can be supported on the second latch, A second end of the second spring can be supported on the second section. The first hook and the second latch can be designed and arranged such that the first hook holds the second latch in the release position by a hook blocking section when the first hook is in its first position, and that, furthermore, a transfer of the first hook into its second position (e.g. by actuation of the actuating section) allows a transfer of the second latch into its locking position, in particular driven by the second spring or the first/second spring.

The first hook can have an engaging section into which the second latch engages with a locking section when the first hook is in its second position and the second latch is in its locking position. The second latch can have a first contact section for contact with the transfer element (see below). The second latch can also be L-shaped, in particular in such a way that the end of one arm of the L-shape forms the locking section and/or that the other arm of the L-shape (completely or in sections) forms the contact section. The second latch can be made of metal (at least 50% by weight or at least 80% by weight), in particular of steel. The second latch can be translationally (alternatively: rotationally or with translational and rotational part) switchable between locking position and release position.

Preferably, the first section has a plurality of at least two, preferably at least 4 and/or at most 15, preferably at most 10 (e.g. 8 or 9 or 10), recesses spaced apart from one another in the longitudinal direction, each of which is suitable for receiving a blocking section of the first latch. The distance between two recesses can be in the range of 1 cm-2 cm, e.g. 15 mm, and/or be at least 3% and/or at most 50% of a maximum extension. In particular, the recesses can be through-holes.

Preferably, the first latch of the telescopic system has a blocking section which can be selectively brought into or out of engagement with a mating structure, in particular with one of the recesses of the first section, in order to adjust the second section relative to the first section with respect to the length of the telescopic system (in the longitudinal direction), wherein the blocking section can preferably assume at least one retracted position (in conjunction with the retracted position of the first latch) corresponding to the first configuration and/or wherein the blocking section can assume an extended position (in conjunction with the extended position of the first latch) corresponding to the second and/or the third configuration. In particular, the blocking section is wedge-shaped at least in sections.

Additionally or alternatively, the first latch preferably comprises a first engaging section for being held in the extended position according to the third configuration. The first engaging section may be adapted to cooperate with a latch blocking section of the transfer element (see further below) and to hold the first latch in the extended position when the transfer element is in a second non-drive position (see further below).

Additionally or alternatively, the first latch preferably comprises a second engaging section for being held in the retracted position according to the first configuration. The second engaging section may be adapted to cooperate with a drive section of the transfer element such that the first latch is driven to the retracted position when the transfer element is transferred to a drive position (see further below).

Adjacent to the first engaging section (in particular as a recess between the first engaging section and the second engaging section), a free space can be provided such that the latch blocking section is opposite the free space when the transfer element is in the drive position, so that the latch blocking section of the transfer element (see below) does not block the first latch from switching to the retracted position.

The first latch can be pretensioned towards the extended position, in particular by at least a third spring. The first latch can also be rotatable about a second axis, which is preferably stationary relative to the second section, and can have a second axis section or a second bearing section for this purpose. The third spring (or at least a third of possibly several third springs) can be fastened to the first latch on the second axis, in particular supported and/or mounted, and/or can be designed as a torsion spring.

Alternatively or additionally (in particular if several third springs are provided), the third spring (or at least a third of possibly several third springs) can also be fastened to the first latch at a distance from the second axis, in particular supported and/or mounted, and/or be designed as a tension spring. Other types of springs are also conceivable, in particular two third springs (redundant) can also be provided.

Additionally or alternatively, the first latch preferably comprises a third engaging section, in particular as part of the blocking section, which according to the second configuration may be adapted to be contacted by an edge of a (respective, in particular above) mating structure, in particular recess of the first section, when a force pushes the first and second sections towards each other to reduce the length of the telescopic system, wherein the third engaging section is preferably oblique (inclined) with respect to the longitudinal direction, so that the first latch is pushed towards the retracted position by the contacting of the third engaging section and the associated force.

In the extended position of the first latch, a side of the blocking section opposite the third engaging section can be arranged at least substantially perpendicular to the longitudinal direction (in particular, forming an angle of 80° to 100° with the longitudinal direction). Alternatively or additionally, in the extended position of the first latch, one side of the blocking section forming the third engaging section can form an angle in the range of 35° to 55°, preferably 45°, with the longitudinal direction.

Preferably, the telescopic system has a transfer element, in particular the transfer element already described above, which is arranged movably, preferably displaceably, in particular longitudinally displaceably, (with or without a rotational component) between at least a first non-drive position, a second non-drive position and a drive position in and/or on the second section.

The transfer element preferably has a drive section which is suitable for selectively interacting with the second engaging section of the first latch in order to transfer the latter from the extended position to the retracted position. The drive section can be formed by a surface which is at least essentially designed in such a way that the longitudinal direction forms its surface normal.

In addition or alternatively, the transfer element preferably has a latch blocking section which is suitable for selectively interacting with the first engaging section of the first latch in order to prevent the latter from being transferred from the extended position to the retracted position. The latch blocking section may have a blocking surface which is straight in the longitudinal direction or inclined with respect thereto by at least 5° and/or at most 30°, preferably at most 20°. If the latch blocking section is inclined, then preferably such that a transfer of the transfer element from the second non-drive position (in which the latch blocking section blocks a transfer of the first latch into the retracted position) into the first non-drive position (which is associated with the locking position of the second latch) is facilitated or is possible even if a force pushes the first latch in the direction of the retracted position.

Preferably, the first latch and the transfer element are matched to each other in such a way that a force for transferring the first latch from the extended position to the retracted position can be transmitted to a (not predominant) extent by the first engaging section to the latch blocking section in order to push the transfer element from the second non-drive position to the first non-drive position.

Preferably, the first latch is designed as a single piece, possibly monolithic.

The transfer element may be pretensioned, in particular by the second spring, towards the first non-drive position in which the latch blocking section does not prevent the first latch from being transferred from the extended position to the retracted position and in which the drive section does not cooperate with the first latch to transfer it from the extended position to the retracted position. In the first non-drive position, the adjustment of the length of the telescopic system may be permitted or enabled to a limited extent. The transfer element and the second latch can be designed and arranged such that the second latch is in the locking position when the transfer element is in the first non-drive position. In one embodiment, the transfer element comprises a second contact section for abutting against the first contact section of the second latch.

Additionally or alternatively, the transfer element is preferably operatively connected to the second latch in such a way that a movement of the transfer element, optionally by means of an actuating element (of the telescopic system), can release or releases the second latch for switching between the release position and/or the locking position. In particular, a movement of the transfer element by means of the actuating element can transfer the second latch from the locking position to the release position.

The transfer element can be made of plastic (at least 50% by weight or at least 80% by weight), in particular as an injection-molded part. The second latch and the transfer element can be firmly connected to one another, for example by fastening means, and/or a section of the second latch, in particular the first contact section, can be extrusion-coated.

If, according to the embodiment, the second latch is made of metal (at least 50% by weight or at least 80% by weight), in particular steel, and the transfer element is made of plastic (at least 50% by weight or at least 80% by weight), high stability can be achieved in a relevant area on the one hand and weight and/or costs can be saved on the other.

In an alternative embodiment, the second latch and transfer element can be monolithic in design.

In general, in particular the first hook, the first latch and/or the second latch can be made of metal (at least 50% by weight or at least 80% by weight), in particular steel.

The transfer element can have a second guide between the second section and the transfer element, specifically, for example, by means of a clearance, optionally a guide groove or slot and a third projection, optionally a guide pin or bolt.

In a further embodiment, the transfer element has a deblocking section which is movable in the longitudinal direction relative to the other components of the transfer element and which is pretensioned with a fifth spring in the direction of the proximal end of the second section. This embodiment addresses the problem that it is at least theoretically conceivable that the first latch comes to a standstill precisely between two recesses of the first section and can then block the entire telescopic system. This is because if the first latch comes to a stop precisely between two recesses of the first section and a user attempts to transfer the second latch from its locking position to the release position by actuating the actuating element in order to enable the first hook to be switched from the second position to the first position, the latch blocking section of the transfer element can run against the first engaging section of the first latch. According to this embodiment, however, the transfer element, with the exception of the deblocking section, can be pushed towards the proximal end against the force of the fifth spring, so that the second latch can nevertheless move to the release position and the first hook can move to the first position, thereby preventing the telescopic system from blocking.

In a further embodiment, the transfer element can have a detection section that is suitable for being detected by, for example, a sensor for determining the position of the transfer element. Accordingly, the second section may, for example, include a sensor that is suitable for preferably detecting the position of the transfer element. In particular, whether the transfer element is in the first non-drive position and the first hook is in its second position (wherein the telescopic system is coupled to the motor vehicle seat), so that it can be detected whether a child seat connected to the telescopic system or a base for a child seat connected to the telescopic system is in a state of use. The detection section and sensor are preferably adjacent to each other. Further, the detection section and the sensor may preferably be disposed between the first latch and the proximal end of the second section, or they may be disposed between the first latch and the first hook.

The transfer element is preferably operatively connected to the actuating element (of the telescopic system) for actuation by a user.

Preferably, the transfer element has support sections that rest directly on the second section in order to support the transfer element on the second section and, optionally, to allow the transfer element to slide along the second section. The support sections can in particular be designed as projections, wherein a support section can preferably be provided at the height of the latch blocking section opposite the blocking surface.

Furthermore, the telescopic system preferably has a first pin which is connected, in particular fixedly, to the second section and/or a second pin which is connected, in particular fixedly, to the transfer element, wherein the first and second pins are preferably provided for connection to an/the actuating element, wherein the first section preferably has a lateral guide slot which extends in the longitudinal direction, preferably over at least 50% of the length of the first section, wherein further preferably both the first pin and the second pin extend through this. The minimum and maximum length of the telescopic system can be defined by the lateral guide slot.

Preferably, the second section has an elongated hole which overlaps with a section of the lateral guide slot of the first section and guides a movement of the second pin in the longitudinal direction towards or away from the first pin.

Preferably, an actuating element, in particular the actuating element already described above, is provided, in particular for, preferably (indirect or direct) manual, actuation (for setting the first, second and third configuration) by the user. A fixed section of the actuating element is preferably connected to the second section via a/the first pin(s), in particular fixedly, and a movable section of the actuating element is preferably operatively connected to the transfer element via a second pin(s) and/or movable relative to the fixed section. Further preferably, the actuating element or the movable section thereof can be blocked by a holding device, in particular a third latch, wherein a release actuation can be provided in order to release the holding device. The actuating element, in particular its release actuation, can comprise at least one knob and/or at least one button and/or at least one slider and/or at least one operating lever.

Preferably, the movable section of the actuating element can be moved relative to the fixed section (and thus also to the second section), in particular against the force of a fourth spring.

The telescopic system preferably has an installation position (see further below), wherein the first hook is in the first position, the second latch is in the release position (held by the hook blocking section of the first hook), the transfer element is in the second non-drive position and the first latch is in the extended position according to the third configuration, wherein the release actuation (of the actuating element) is not actuated by the user.

In the event that, according to a preferred embodiment, the user (firmly) presses the first hook, in particular its actuating section, against the vehicle-side bracket, for example starting from the installation position, wherein the release actuation is (still not) actuated, the second latch is transferred to the locking position and the transfer element is transferred from the second to the first non-drive position, wherein the first latch is (still) in the extended position according to the second configuration, and the first hook is transferred to the second position (by actuation of the actuating section by the vehicle-side bracket), wherein the two legs of the first hook engage around the vehicle-side bracket, so that the telescopic system is transferred to a locking position (see below).

In the event that, according to a preferred embodiment, the user, for example, actuates the release actuation starting from the locking position (now), in particular presses increasingly, the transfer element is (initially) (again) transferred from the first to the second non-drive position and the second latch is (again) held in the release position by the hook blocking section of the first latch, wherein the first latch is (now) (still) in the extended position according to the third configuration, and wherein the first hook is moved to the first position (by the pretensioned first and/or first/second spring) so that the telescopic system is (again) transferred to the installation position.

In the event that, according to a/the preferred embodiment, the user actuates the release actuation starting from the installation position for example, in particular increasingly presses, the transfer element is transferred from the second non-drive position to the drive position, wherein the second latch is (still) in the release position, and wherein the first latch is driven to the retracted position according to the first configuration, wherein the first hook is (still) in the first position, so that the telescopic system is transferred to an adjustment position (see further below).

In the event that, according to a/the preferred embodiment, the user no longer actuates the release actuation from the adjustment position, for example, and in particular releases the release actuation (slowly or abruptly), the telescopic system is transferred (again) to the installation position.

In a further embodiment, the fixed section of the actuating element has a through-hole or slot on its outer side in which, depending on the position of the movable section relative to the fixed section, color markings can be seen on the movable section to indicate the current position of the first hook.

The actuating element can be provided (directly) on one of the first and second sections or at a distance from the first and second sections.

The telescopic system (as a whole) can preferably be moved to the following positions:
an adjustment position, in particular the one already described above, in which the first hook is in the first position, the second latch is in the release position and the transfer element is in the drive position, wherein the first latch is in the retracted position according to the first configuration and the actuating element is actuated (in particular the user actuates the release actuation, in particular (permanently) presses and/or keeps pressed), wherein the telescopic system and thus the child seat or the base for a child seat is not fastened to the motor vehicle seat, so that the length of the telescopic system is (freely) adjustable (between the minimum and maximum length), and/or
a locking position, in particular the one already described above, in which the first hook is in the second position, the second latch is in the locking position and the transfer element is in the first non-drive position, wherein the first latch is in the extended position according to the second configuration and the actuating element is not actuated (in particular the user does not actuate the release actuation, in particular does not (increasingly) press and/or hold it pressed), so that the telescopic system and thus the child seat or the base for a child seat is fastened to the motor vehicle seat, wherein the length of the telescopic system is exclusively reducible (in particular when a force acts on the first section or on the child seat or the base for a child seat, which forces the first and second sections towards each other), and/or
an installation position, in particular the one already described above, in which the first hook is in the first position, the second latch is in the release position and the transfer element is in the second non-drive position, wherein the first latch is in the extended position according to the third configuration and the actuating element is not actuated (in particular the user does not actuate the release actuation, in particular does not (increasingly) press and/or hold it pressed), wherein the telescopic system and thus the child seat or the base for a child seat is not fastened to the motor vehicle seat, so that the length of the telescopic system can be changed to a further limited extent or cannot be changed compared to the second configuration, and/or
an intermediate position when the telescopic system is shortened from the locking position and the first latch has not yet reached the next recess (of the first section) (wherein in particular the first hook is in the second position, the second latch is in the locking position, the transfer element is in the first non-drive position and the first latch is in the retracted position; the actuating element is not actuated (in particular the user preferably does not actuate the release actuation, in particular does not (increasingly) press and/or hold it pressed); and the telescopic system and thus the child seat or the base for a child seat is fastened to the motor vehicle seat), wherein the length of the telescopic system can be increased slightly (for example by at least 2 mm or at least 4 mm and/or at most 2 cm or at most 1 cm), in particular until the first latch engages in the previous recess (of the first section) when the first section and the second section are pulled apart.

As in the locking position, the intermediate position can allow the length of the telescopic system to be reduced (in particular when a force acts on the first section or on the child seat or the base for a child seat, which pushes the first and second sections towards each other), By allowing a slight movement in the other direction in the intermediate position, it can be easily achieved that the user can at least bring about an engagement with the previous recess, which in particular improves user-friendliness and safety.

Parts made of metal, in particular punched parts, comprising for example the first hook and/or the first latch and/or the second latch, can have different thicknesses and thereby have thin areas to enable the punching of smaller holes. The thin areas can be formed from the areas of normal thickness by applying high pressure (e.g. by a type of hammer blow).

The above-mentioned object is also solved in particular by a child seat or base for a child seat, comprising two telescopic systems arranged side by side as described above, in particular for fastening the child seat or base for a child seat on a motor vehicle seat, in particular compatible with an Isofix anchorage or an anchorage according to standard ISO 13216 or UN ECE R 145.

Furthermore, the above-mentioned object is solved in particular by a method for fastening a child seat or a base for a child seat, as described above, to a motor vehicle seat, wherein first and second sections are displaced relative to one another in the longitudinal direction in order to adjust the length of the telescopic system, wherein the telescopic system is selectively brought into the first, third and/or second configuration, preferably (successively) into the first, third and second configuration. Further method features result from the above and following description of the telescopic system or the child seat or the base. In particular, functional features can be carried out as specific method steps (for example, a transfer from the third configuration to the second configuration can be specifically carried out or initiated).

Furthermore, the above-mentioned object is also solved in particular by a method for detaching a child seat or a base for a child seat, as described above, from a motor vehicle seat, wherein the method in particular follows or precedes the method described in the preceding paragraph, wherein the telescopic system is moved from the second configuration to the third configuration or from the second configuration to the first configuration (optionally via the third configuration), Further method features result from the above and following description of the telescopic system or the child seat or the base. In particular, functional features can be carried out as specific method steps (for example, a transfer from the second configuration to the third configuration can be specifically carried out or initiated).

Further embodiments are shown in the sub-claims.

In the following, the invention is described with reference to exemplary embodiments, which are explained in more detail with reference to the illustrations, wherein:

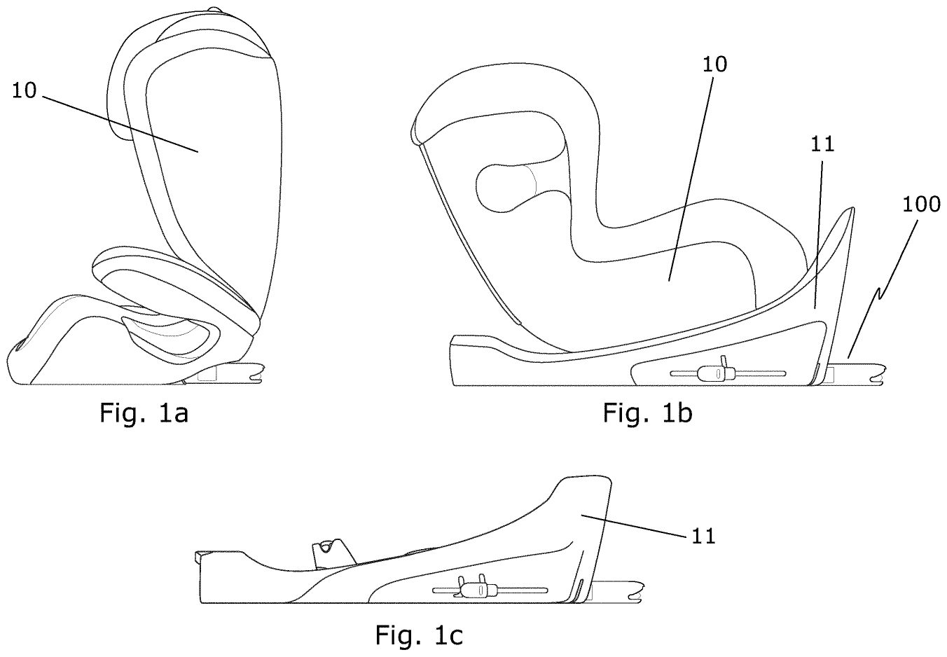

FIG. 1a shows a child seat with a telescopic system according to the invention;

FIG. 1b shows the child seat according to FIG. 1a on a base for a child seat with the telescopic system;

FIG. 1c shows the base for a child seat with the telescopic system;

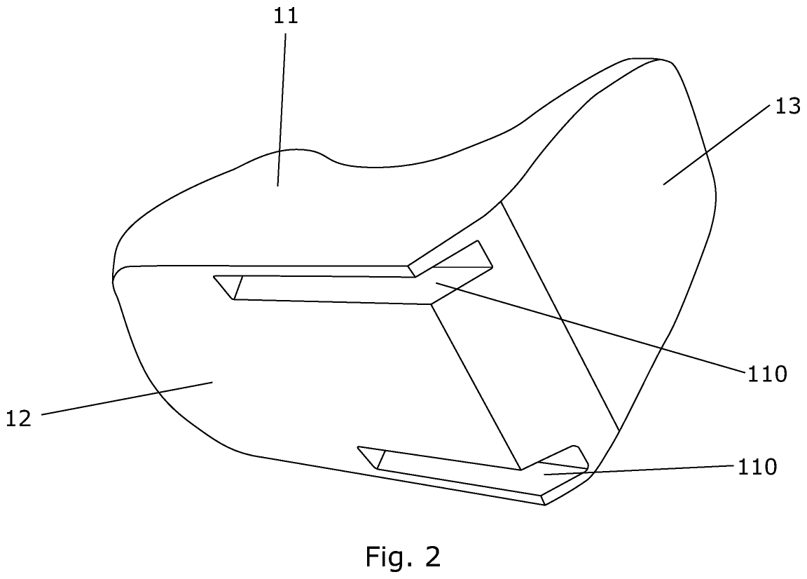

FIG. 2 shows the base for a child seat with an underside for support on a seat surface of a motor vehicle seat;

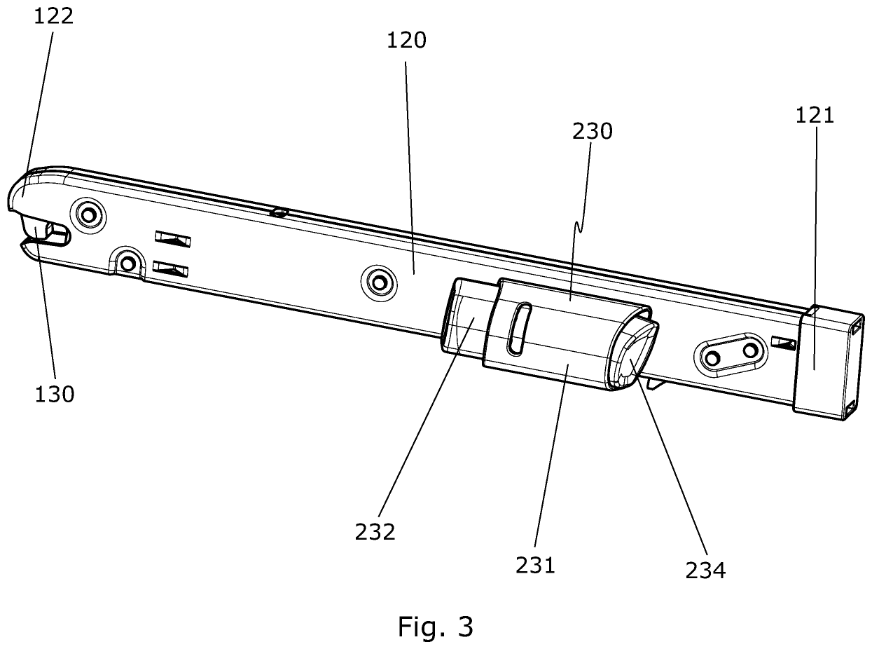

FIG. 3 shows a second section of the telescopic system according to the invention with an actuating element arranged laterally on the second section with a non-actuated release actuation;

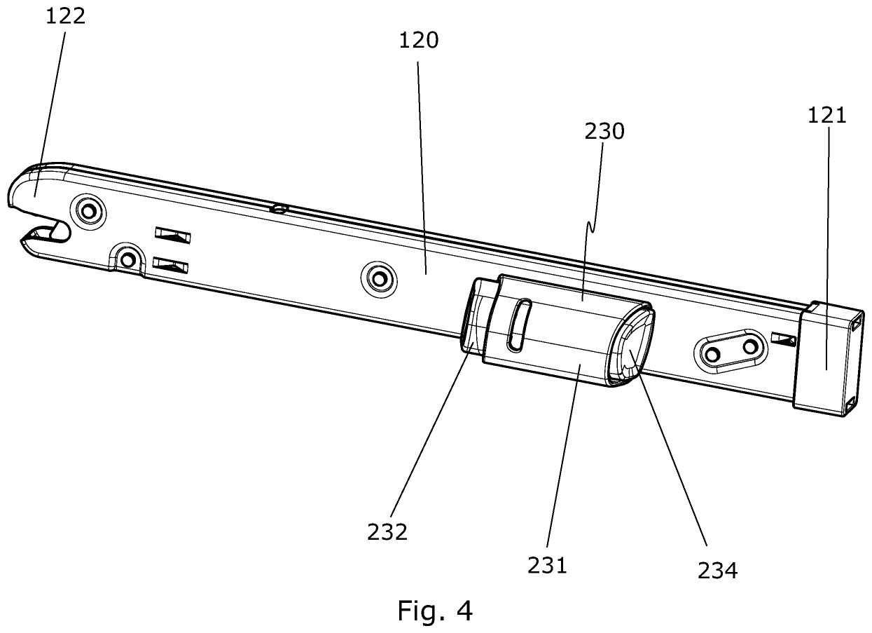

FIG. 4 shows an illustration analogous to FIG. 3 with actuated release actuation;

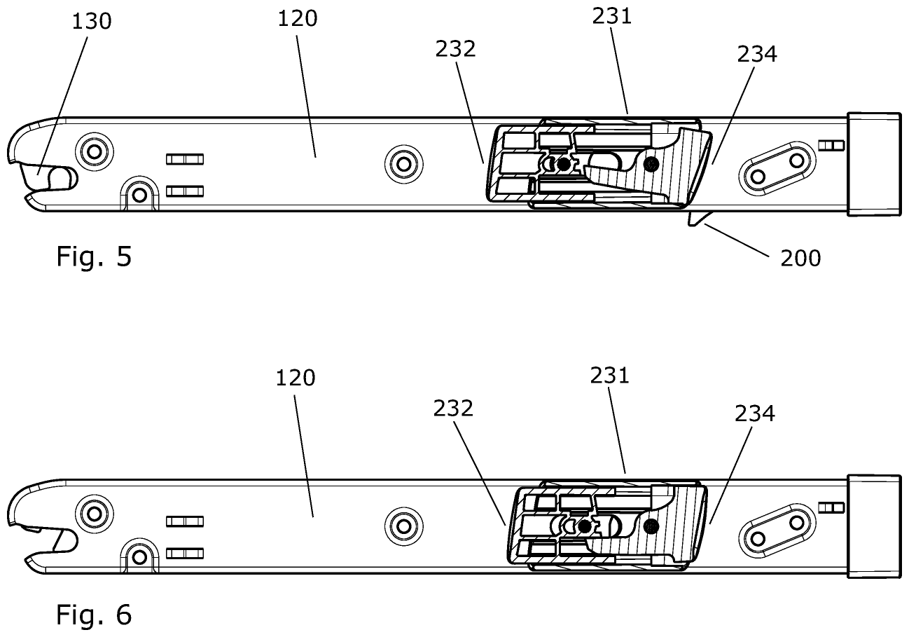

FIG. 5 shows an illustration corresponding to FIG. 3, but now the internal structure of the non-actuated actuating element can be seen;

FIG. 6 shows an illustration corresponding to FIG. 4, but now the internal structure of the actuated actuating element can be seen;

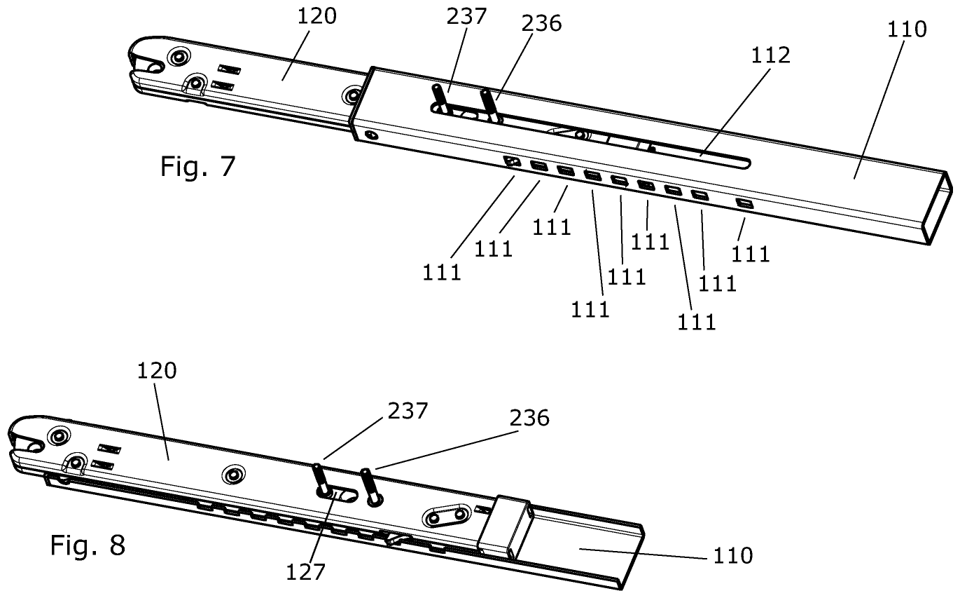

FIG. 7 shows the telescopic system with a first section and the second section;

FIG. 8 shows the telescopic system with only one half of the first section;

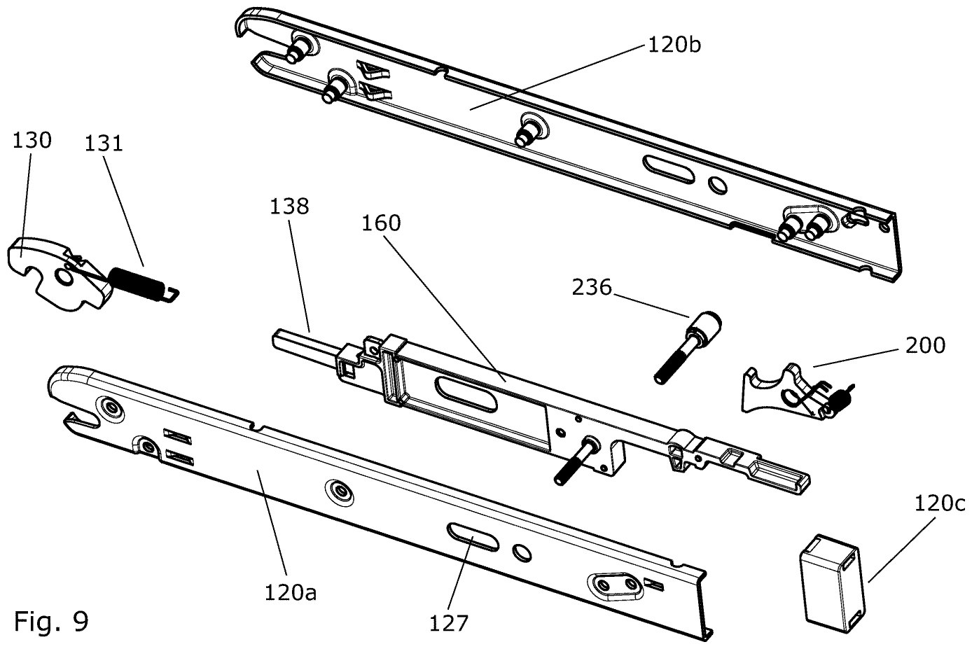

FIG. 9 shows an exploded view of the second section of the telescopic system;

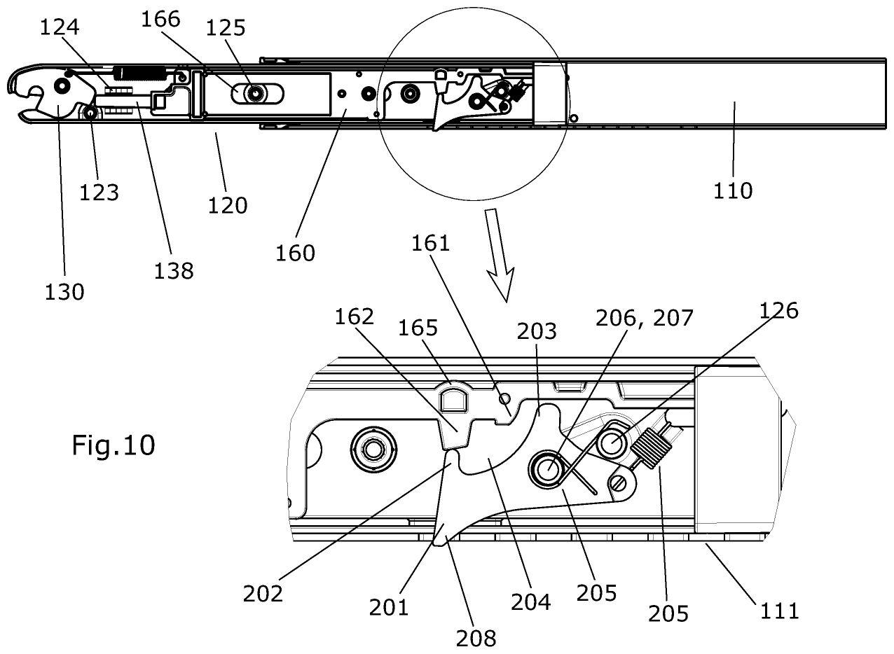

FIG. 10 shows an illustration of the entire telescopic system with an enlarged view of a first bolt and various sections of a transfer element;

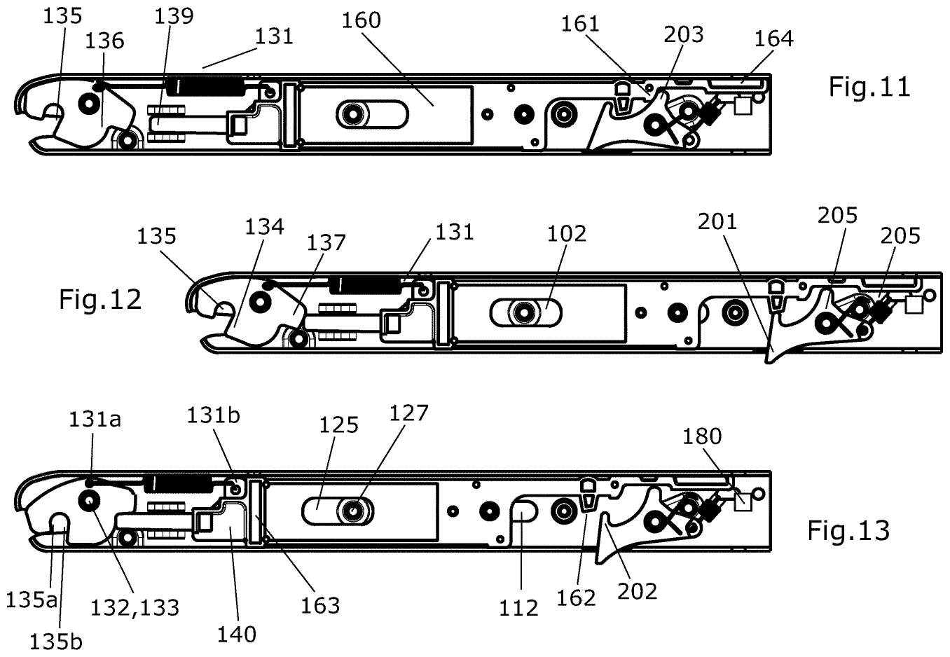

FIG. 11 shows one half of the second section of the telescopic system with first latch according to a first configuration;

FIG. 12 shows one half of the second section of the telescopic system with first latch according to a third configuration;

FIG. 13 shows one half of the second section of the telescopic system with first latch according to a second configuration;

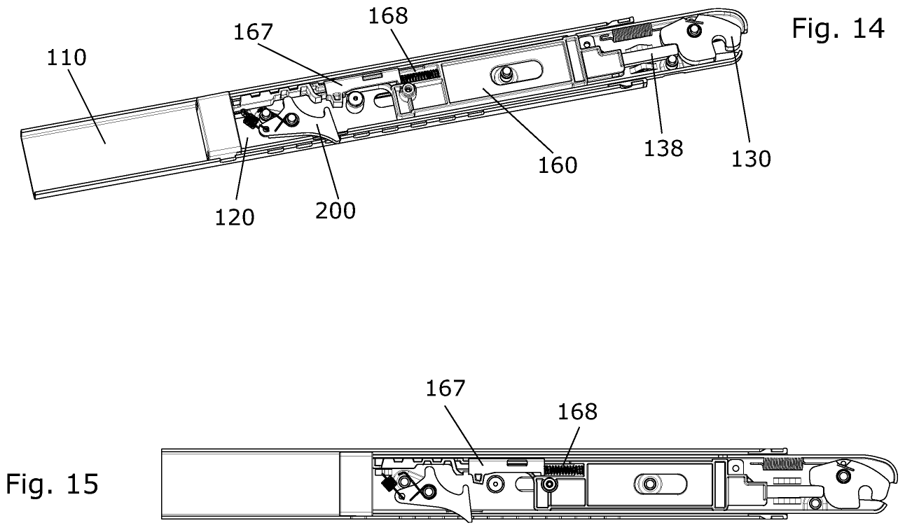

FIG. 14 shows an alternative embodiment of a telescopic system according to the invention, wherein the transfer element has a deblocking section which is movable in the longitudinal direction relative to the other components of the transfer element and is pretensioned with a fifth spring;

FIG. 15 shows the telescopic system as shown in FIG. 14 in a locking position;

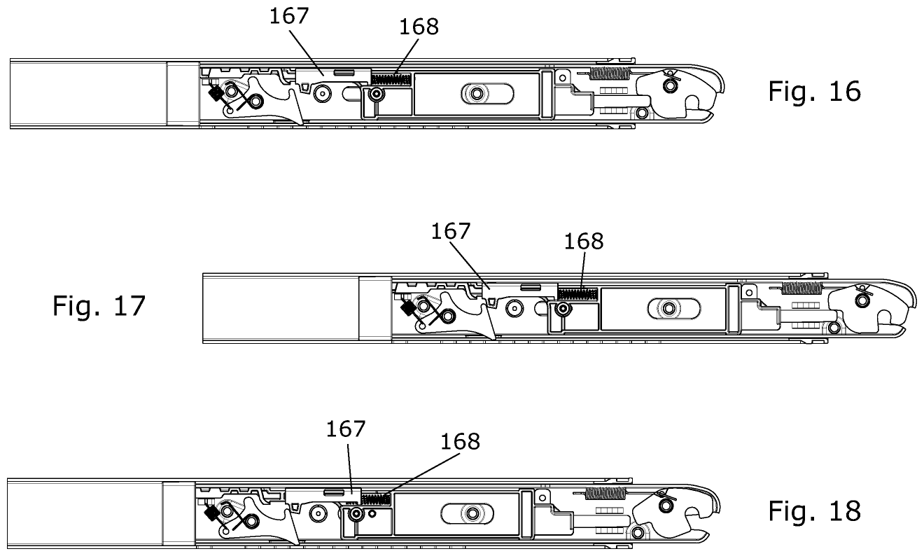

FIG. 16 shows the telescopic system as shown in FIG. 14 with the first latch raised compared to FIG. 15;

FIG. 17 shows the telescopic system as shown in FIG. 14, wherein the first latch is located exactly between two recesses of the first section;

FIG. 18 shows the telescopic system as shown in FIG. 14, wherein the transfer element is pushed towards a proximal end (of the second section) with the exception of the deblocking section, so that a second latch is in a release position relative to FIG. 17;

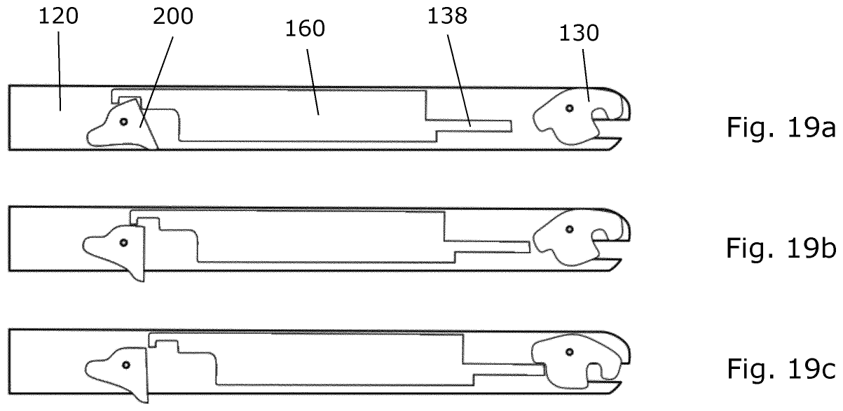

FIG. 19a shows an interaction of parts of the telescopic system in its adjustment position;

FIG. 19b shows an interaction of parts of the telescopic system in its installation position; and

FIG. 19c shows an interaction of parts of the telescopic system in its locking position.

In the following description of the figures, the same reference numbers are used for identical and identically acting parts.

FIG. 1a shows a child seat 10 having a telescopic system 100 according to the invention.

FIG. 1b shows the child seat 10 on a base for a child seat 11 with the telescopic system 100.

FIG. 1c shows the base for a child seat 11 with the telescopic system 100.

FIG. 2 shows the base for a child seat 11 with an underside 12 for resting on a seat surface of a motor vehicle seat, and with a rear side 13 which is provided to point in the direction of a backrest of the motor vehicle seat. Integrally formed with the base for the child seat 11, two first sections 110 of the telescopic system according to the invention are shown schematically. The two first sections 110 are flush at the bottom with the underside 12 of the base for the child seat 11.

They also do not protrude rearwardly beyond the rear side 13.

FIG. 3 shows a second section 120 of the telescopic system with a proximal end 121 formed as an end cap and a distal end 122. Also shown to the side of the second section 120 is an actuating element 230 with a fixed section 231 and a movable section 232 as well as a release actuation 234. The fixed section 231 has a through-hole (without reference numeral) on its outer side in which, depending on the position of the movable section 232 relative to the fixed section 231, color markings not shown on the movable section 232 can be seen to indicate the momentary position of the first hook 130 shown here in its second position. The release actuation 234 is not actuated, and the movable section 232 is in an initial position. The first hook 130 is located at the distal end 122 of the second section 120 and can be switched between a first position and a second position, In the second position, it includes a notch (without reference numeral) at the distal end 122 of the second section 120.

In FIG. 4, the same elements are shown as in FIG. 3, but in contrast to this, the release actuation 234 is now actuated and the movable section 232 is in a depressed position. The first hook 130 is in its first position, so that now only the actuating section 134 can be seen.

FIG. 5 corresponds to FIG. 3 and FIG. 6 corresponds to FIG. 4. However, the internal structure of the actuating element 230 can now be seen in each case: It can be seen that the release actuation 234 is mounted rotatably about an axis (without reference numeral). Its actuation against the force of a spring, which is not shown, pivots an end formed as a third latch (holding device) downwards and allows the movable section 232 to be pressed in towards the proximal end 121. The movable section 232 is also pressed in against the force of a spring, which is also not shown, and results in the first hook 130 being transferred to the first position, as explained in detail later.

FIG. 7 shows the telescopic system 100 according to the invention with the first section 110 and the second section 120. The first section 110 has a plurality of recesses 111, shown here as through-holes, on its underside. On the side facing the actuating element 230, which is not shown here, the first section 110 also has a lateral guide slot 112. A first pin 236 and a second pin 237 extend through this, which are provided for connection to the actuating element 230. The telescopic system 100 according to the invention is in maximum extension.

FIG. 8 shows the telescopic system 100 according to the invention, wherein only one half of the first section 110 is shown here for reasons of understanding, The telescopic system 100 according to the invention is shown here retracted relatively far back and it can be seen that the first pin 236 is firmly connected to the second section 120. In addition, it can now be seen that the second section has an elongated hole 127 through which the second pin 237 extends.

The exploded view in FIG. 9 shows that the second section 120 comprises a first half 120a and a second half 120b as well as an end cap 120c. Furthermore, the first hook 130 together with a first/second spring 131, a transfer element 160 together with a second latch 138, the first pin 236, a first latch 200 and the elongated hole 127 can be seen.

FIG. 10 again shows a representation of the entire telescopic system 100 according to the invention with the first section 110 and the second section 120. It can be seen that the first hook 130 is supported on a first projection 123 of the second section in the first position shown. The second latch 138 is in the release position and is connected to the transfer element 160. A third projection 125 connects the two halves 120a and 120b of the second section 120 and gives the second section 120 more stability. The third projection 125 of the second section 120, together with a clearance 166 of the transfer element 160, also forms a second guide 102 as a side effect.

In the enlarged view of the first latch 200 and sections of the transfer element 160 shown below, further details can be seen: the first latch 200 has a blocking section 201 that is wedge-shaped. As shown, a first engaging section 202 can cooperate with a latch blocking section 162 to prevent transfer of the first latch 200 from an extended position shown, in which the blocking section 201 is in engagement with one of the recesses 111 of the first section 110, to a retracted position. Opposite the latch blocking section 162, the transfer element 160 has a support section 165 with which it can be supported on the second section 120.

A second engaging section 203 of the first latch 200 is located opposite a drive section 161 of the transfer element 160 and is intended to cooperate with the latter in order to transfer the first latch 200 from the extended position to the retracted position. In the illustrated position of the transfer element 160, however, the drive section 161 and the second engaging section 203 are spaced apart from one another.

Between the first engaging section 202 and the second engaging section 203 is a free space 204, in which the latch blocking section 162 is located when the transfer element 160 is in a drive position. On the side of the blocking section 201 facing the proximal end 121 there is a third engaging section 208, which is intended to cooperate with an edge of the recess 111 with which the first latch 200 is engaged in order to push the first latch 200 in the direction of the retracted position.

The first latch 200 is pivotable about a second axis 206, on which it is mounted with a second bearing section 207. Two third springs 205, one of which is a torsion spring and the other of which is a tension spring, tension the first latch 200 in the direction of the extended position. The third spring 205, which is designed as a torsion spring, is supported at one end on the first latch 200 and at the other end on a fourth projection 126 of the second section 120.

The third spring 205, which is designed as a tension spring, is supported at one end on the first latch 200 and at the other end on the second section 120. It can be seen that the support point of the third spring 205, which is designed as a tension spring, is thinner than the rest of the first latch 200. In the extended position shown, the first latch 200 is supported on the fourth projection 126.

FIG. 11 again shows the second section 120 of the telescopic system 100 according to the invention. A first hook 130 with a locking section 135 is arranged at the distal end 122, wherein the first hook 130 is rotatably supported about a first axis 132 by a first bearing section 133. A first/second spring 131 has a first end 131a fastened to the first hook 130, specifically approximately above the first bearing section 133, and a second end 131b fastened to an arm of the L-shaped second latch 138.

The second latch 138 is movable together with the transfer element 160, which has, among other things, a drive section 161 and a detection section 164, In the illustrated adjustment position of the telescopic system 100 according to the invention, the first hook 130 is in its first position (open), the second latch 138 is in its release position and the transfer element 160 is in the drive position, the first latch 200 is in the retracted position (according to the first configuration) and the actuating element 230 (not illustrated) is actuated. The child seat 10 connected to the telescopic system 100 or the base for a child seat 11 connected to the telescopic system 100 are thus not fastened to the motor vehicle seat 1, and the length of the telescopic system 100 can be freely adjusted between a minimum extension and a maximum extension. A sensor 180 is shown schematically.

FIG. 12 shows the same elements as FIG. 11, but the telescopic system 100 according to the invention is now in an installation position. Furthermore, the first hook 130 is in the first position (open) and the second latch 138 is in the release position. However, the transfer element 160 is now in a second non-drive position and the first latch 200 is in the extended position (according to the third configuration). The actuating element 230 (not shown) is not actuated. The telescopic system 100 is not fastened to the motor vehicle seat 1 and the length of the telescopic system 100 cannot be changed, because the latch blocking section 162 of the transfer element 160 blocks the first latch 200 at the first engaging section 201 and holds it in the extended position.

FIG. 13 shows the elements already shown in FIGS. 11 and 12, but the telescopic system 100 according to the invention is now in a locking position. Now the first hook 130 is in the second position, the second latch 138 is in a locking position and the transfer element 160 is in a first non-driven position. The first latch 200 is in the extended position (according to the second configuration), and the actuating element 230 (not shown) is not actuated. The telescopic system 100 and optionally the child seat 10 or child seat base 11 connected thereto are fastened to the motor vehicle seat 1, and the length of the telescopic system 100 cannot be increased, but can only be decreased when a force acts on the first section 110 or on the child seat 10 or child seat base 11, respectively, urging the first section 110 and second section 120 towards each other. It can be seen that the sensor 180 is now no longer opposite the detection section 164, so that a distinction can be made between the locking position and the release position of the second latch 138 (and thus between the first and second position of the first hook 130).

FIGS. 14-18 show an alternative embodiment of the telescopic system 100 according to the invention. The embodiment essentially corresponds to that shown above, but here the transfer element 160 has a deblocking section 167 which is movable in the longitudinal direction relative to the other components of the transfer element 160 and which is pretensioned in the direction of the proximal end 121 of the second section 120 by a fifth spring 168. The illustrated embodiment addresses the problem that it is at least theoretically conceivable that the first latch 200 comes to rest exactly between two recesses 111 of the first section 110 and can then block the entire telescopic system 100. It should be noted at this point that the first/second spring 131 and the fifth spring 168 are only shown schematically in FIGS. 14-18.

FIG. 15, like FIG. 14, shows the telescopic system 100, where the deblocking section 167 and fifth spring 168 do not yet have any effect compared to the previously illustrated version (FIGS. 1-13).

In FIG. 16, the second latch 138 is still in its locking position relative to the first hook 130. Due to a force urging the first section 110 and the second section 120 towards each other, the first latch 200 has been lifted by interaction of the edge of one of the recesses 111 and the third engaging section 208.

If, as shown in FIG. 17, the first latch 200 comes to rest exactly between two recesses 111 of the first section 110 and a user attempts to transfer the second latch 138 from its locking position to the release position by actuating the actuating element 230 (not shown) to enable the first hook 130 to be switched from the second position to the first position, the latch blocking section 162 may run against the first engaging section 202. Now, as shown in FIG. 18, the transfer element 160 (with the exception of the deblocking section 167) can be pushed toward the proximal end 121 against the force of the fifth spring 168 so that the second latch 138 can still move to the release position.

FIGS. 19a to 19c again show very schematically the basic interaction of parts of the telescopic system 100 according to the invention, specifically the second section 120, the first hook 130, the transfer element 160 with the second latch 138 and the first latch 200. FIG. 19a shows the adjustment position, FIG. 19b shows the installation position, and FIG. 19c shows the locking position.

At this point, it should be noted that all the parts described above are claimed to be essential to the invention when viewed individually and in any combination, in particular the details shown in the drawings. Modifications thereof are familiar to the person skilled in the art.

Furthermore, it is pointed out that the aim is to achieve the broadest possible scope of protection. In this respect, the disclosure contained in the claims can also be specified by features that are described with further features (even without these further features necessarily being included). It is explicitly pointed out that round brackets and the term “in particular” are intended to emphasize the optionality of features in the respective context (which does not mean, conversely, that a feature is to be regarded as mandatory in the corresponding context without such identification). The term “element/-element” is preferably intended to indicate a respective coherent structure, which in turn may be connected to at least one other structure (to form a possibly one-piece and/or inherently non-movable overall structure) or may be delimited from all other structures.

### LIST OF REFERENCE SIGNS

1 Car seat
2 Vehicle seat backrest
3 Vehicle seat surface
4 Bracket
10 Child seat
11 Base for a child seat
12 Underside
13 Rear side
100 Telescopic system
101 First guide
102 Second guide
110 First section
111 Recess
112 (Lateral) guide slot
120 Second section
120a, 120b First and second half
120c End cap
121 Proximal end
122 Distal end
123 First projection
124 Second projection
125 Third projection
126 Fourth projection
127 Elongated hole
130 First hook
131 First/second spring
131a, 131b First and second end of the first/second spring
132 First axis
133 First bearing section
134 Actuating section
135 Locking section
135a, 135b Legs
136 Engagement section
137 Hook blocking section
138 Second latch
139 Locking section
140 First contact section of the second latch
160 Transfer element
161 Drive section
162 Latch blocking section
163 Second contact section of the transfer element
164 Detection section
165 Support section
166 Clearance
167 Deblocking section
168 Fifth spring
180 Sensor
200 First latch
201 Blocking section
202 First engaging section
203 Second engaging section
204 Free space
205 Third spring
206 Second axis
207 Second bearing section
208 Third engaging section
230 Actuating element
231 Fixed section
232 Movable section
233 Holding device
234 Release actuation
235 Fourth spring
236 First pin
237 Second pin

1. A telescopic system for fastening a child seat or a base for a child seat to a motor vehicle seat, wherein the telescopic system comprises;
a first section and
a second section,
wherein the first and second sections are displaceable relative to one another in a longitudinal direction in order to adjust a length of the telescopic system,
wherein a first latch is fastened in or on the second section,
wherein the telescopic system can be brought into at least a first configuration, a second configuration and a third configuration,
wherein in the first configuration the adjustment of the length of the telescopic system is enabled, in the second configuration the adjustment of the length of the telescopic system is enabled to a limited extent compared to the first configuration and in the third configuration the adjustment of the length of the telescopic system is enabled to a further limited extent compared to the second configuration or is not possible.

2. The telescopic system according to claim 1,
wherein the first section is fastened or can be fastened to the child seat or the base for the child seat, detachably, and/or is integrally formed at least in sections with the child seat or the base for the child seat,
wherein the second section is provided for detachable fastening to a motor vehicle seat and has a proximal end and a distal end,
wherein a first hook is provided in a region of the distal end of the second section, which hook is suitable for engaging around a bracket (4) provided on a vehicle side, in particular an Isofix anchorage or an anchorage according to standard ISO 13216 or UN ECE R 145, in order to couple the telescopic system to the motor vehicle seat,
wherein the first hook is switchable between a first position, in which it does not couple the telescopic system to the motor vehicle seat, and a second position, in which it couples the telescopic system to the motor vehicle seat.

3. Telescopic The telescopic system according to claim 1,
wherein the second section is at least 4 cm, or the first section is at most 40 cm long or at least half as long as the second section.

4. The telescopic system according to claim 1,
wherein a minimum length of the telescopic system and a maximum length of the telescopic system differ by at least 4 cm.

5. The telescopic system according to claim 1,
wherein a second latch is provided in or on the second section, which is adjustable between a locking position in which the second latch holds a first hook in its second position or a release position in which the second latch does not hold the first hook in its second position.

6. The telescopic system according to claim 5,
wherein the first section has a plurality of at least two recesses spaced apart from each other in the longitudinal direction.

7. The telescopic system according to claim 6,
wherein the first latch has a blocking section which can be selectively brought into or out of engagement with a mating structure, in particular with one of the recesses, of the first section in order to adjust the second section relative to the first section with respect to the length of the telescopic system in the longitudinal direction,
wherein the blocking section can assume at least one retracted position corresponding to the first configuration or
wherein the blocking section can assume an extended position corresponding to the second and/or the third configuration, or has a first engaging section for being held in the extended position according to the third configuration or has a second engaging section for being held in the retracted position according to the first configuration or a third engaging section, in particular as part of the blocking section, which according to the second configuration is adapted to be contacted by an edge of a mating structure, in particular recess of the first section, when a force pushes the first and second sections towards each other to reduce the length of the telescopic system,
wherein the third engaging section is oblique with respect to the longitudinal direction, so that the first latch is pushed towards the retracted position by the contacting of the third engaging section and an associated force.

8. The telescopic system according to claim 7, that wherein a transfer element is provided, which is arranged movably, displaceably, in particular longitudinally displaceably, between at least a first non-drive position, a second non-drive position and a drive position in or on the second section, wherein the transfer element has a drive section which is suitable for selectively interacting with the second engaging section of the first latch in order to transfer the latter from the extended position to the retracted position, or has a latch blocking section which is suitable for selectively interacting with the first engaging section of the first latch in order to prevent the latter from being transferred from the extended position to the retracted position, or is operatively connected to the second latch in such a way that a movement of the transfer element, releases the second latch for switching between the release position and/or a locking position.

9. The telescopic system according to one of claim 1,
wherein a first pin is connected, in particular fixedly, to the second section or a second pin is connected, in particular fixedly, to a transfer element, wherein the first and second pins are provided for connection to an/the actuating element,
wherein the first section has a lateral guide slot which extends in the longitudinal direction, over at least 50% of the length of the first section, wherein further both the first pin and the second pin extend therethrough.

10. The telescopic system according to claim 9,
wherein the second section has an elongated hole which overlaps with a section of the lateral guide slot of the first section and guides a movement of the second pin in the longitudinal direction towards or away from the first pin.

11. The telescopic system according to claim 1,
wherein an actuating element is provided, in particular for actuation by a user,
wherein a fixed section of the actuating element is connected to the second section via a/the first pin, in particular fixedly, and a movable section of the actuating element is operatively connected to a transfer element via a second pin and is movable relative to the fixed section and can be blocked by a holding device, in particular a third latch, wherein a release actuation is provided in order to release the holding device.

12. The telescopic system of claim 8,
wherein it can be brought into the following positions:
an adjustment position in which the first hook is in the first position, the second latch is in the release position and the transfer element is in the drive position, wherein the first latch is in the retracted position according to the first configuration and an actuating element is actuated, so that the telescopic system and thus the child seat or the base for a child seat is not fastened to the motor vehicle seat, so that the length of the telescopic system is adjustable, or
a locking position in which the first hook is in the second position, the second latch is in the locking position and the transfer element is in the first non-drive position, wherein the first latch is in the extended position according to the second configuration and the actuating element is not actuated, so that the telescopic system and thus the child seat or the base for a child seat is fastened to the motor vehicle seat, wherein the length of the telescopic system is exclusively reducible, or
an installation position in which the first hook is in the first position, the second latch is in the release position and the transfer element is in the second non-drive position, wherein the first latch is in the extended position according to the third configuration and the actuating element is not actuated, so that the telescopic system and thus the child seat or the base for a child seat is not fastened to the motor vehicle seat, so that the length of the telescopic system can be changed to a further limited extent or cannot be changed compared to the second configuration, or
an intermediate position when the telescopic system is shortened from the locking position and the first latch has not yet reached a next recess, wherein the length of the telescopic system can be slightly increased, in particular until the first latch engages in a previous recess when the first section and the second section are pulled apart.

13. A child seat or base for a child seat, comprising two telescopic systems with each of the two telescopic systems configured according to claim 1 and arranged side by side, in particular for fastening the child seat or the base for a child seat on a motor vehicle seat, in particular compatible with an Isofix anchorage or an anchorage according to standard ISO 13216 or UN ECE R 145.

14. A method for fastening the child seat or the base for a child seat, according to the claim 13, to the motor vehicle seat,
wherein first and second sections are displaced relative to one another in the longitudinal direction to adjust the length of the telescopic system,
wherein the telescopic system is selectively brought into the first, third or second configuration,

15. A method for detaching the child seat or the base for a child seat according to claim 13 from the motor vehicle seat,
wherein the telescopic system is moved from the second configuration to the third configuration or from the second configuration to the first configuration.
